(19) United States
(12) Patent Application Publication
(10) Pub. No.: US 2024/0286712 A1
(43) Pub. Date: Aug. 29, 2024

(54) PAIR OF EXTENDED ARMS COUPLED TO A VESSEL

(71) Applicant: Nobuyoshi MORIMOTO, Tokyo (JP)

(72) Inventor: Nobuyoshi MORIMOTO, Tokyo (JP)

(21) Appl. No.: 18/541,741

(22) Filed: Dec. 15, 2023

(30) Foreign Application Priority Data
Feb. 23, 2023 (IN) 202311012491

(51) Int. Cl. B63B 1/40; B63B 1/06; B63B 1/38

(52) U.S. Cl. CPC B63B 1/40; B63B 1/063; B63B 1/38

(57) ABSTRACT

The present invention provides a vessel (10) comprising: a bow (100) having a port side and a starboard side, a pair of extended arms (101, 102) comprising: a port side extended arm (101) operationally coupled to the port side of the bow (100), and a starboard side extended arm (102) operationally coupled to the starboard side of the bow (100), the pair of extended arms (101, 102) configuring a trapezoidal zone and bifurcating an incoming wave towards the vessel (10) into three directions: towards port side, toward starboard side and a center wave into the trapezoid pool (103), thereby reducing impact of wave resistance on the vessel (10). The trapezoid pool (103) facilities the generation of air bubbles (500) by collisions of the center wave with the bow (100) and the pair of extended arms (101, 102).

### FIELD OF THE INVENTION

The present invention generally relates to a bow structure of vessels such as ships. More specifically, the present invention relates to an apparatus having a pair of extended arms coupled to the bow structure of vessels.

### BACKGROUND OF THE INVENTION

Vessels such as ships, yachts, boats or the like travel in various water bodies including but not limited to oceans, canals, rivers and other deep water bodies, and carry cargo or passengers. Such vessels also support specialized missions for defense, research, or fishing. Vessels additionally support exploration, trade, warfare, migration, colonization, and science. Vessel transport is responsible for the largest portion of world commerce.

A vessel generally travels in a medium that provides more drag resistance as compared to air. The drag resistance refers to the energy required to push water out of the way of the vessel. Water waves are created due to this drag resistance. The drag resistance not only reduces speed of the vessel but also increases fuel consumption of the vessel. Therefore, a vessel has to be designed such that components of drag resistance are kept low.

The drag resistance can be controlled by controlling the interaction of water with the vessel at the fore-end. A bow refers to the fore-end part of the vessel which first comes in contact with water.

A vessel with a blunt bow has to push the water away quickly to pass through, and this high acceleration requires large amounts of energy. A bow with a sharper angle to push water out of the way more gradually and to reduce the amount of energy required is already known in the art.

Another type of bow, commonly known as a bulbous bow, is often used on large power ships to reduce drag resistance. The bulb alters the waves generated by the vessel, by varying the pressure distribution ahead of the bow. Due to the nature of its destructive interference with the bow wave, there is a limited range of vessel speeds over which it is effective. A bulbous bow must be designed in order to mitigate the drag resistance of a particular vessel over a particular range of speeds. A bulb that works for one vessel shape and one range of speeds could be detrimental to a different vessel shape or a different speed range. Proper design and knowledge of the intended operation speeds of a vessel and conditions is therefore necessary while designing a bulbous bow.

Another type of bow, generally known as a straight shaped bow is gives more fuel efficiency.

Air Lubrication System is another method to reduce the drag resistance between the vessel and water by using air bubbles. An air blower or a dedicated system is used to generate air bubbles to pass them continuously beneath the surface of the ship. Air bubble outlets are created at different locations along the bottom of the vessel, symmetrically on both sides of the center line of vessel. The air bubble distribution across the vessel surface reduces the drag resistance working on the vessel, creating energy-saving effects. With the right vessel design, the air lubrication system is expected to achieve up to 10-15% reduction of CO₂ emissions, along with significant improvement in vessel's fuel consumption.

Most of the current technologies developed regarding the air lubrication system requires the air blower or the dedicated system to provide constant flow rate of air to form a layer of air bubbles between the vessel and water. The current technology can generate air bubble only at the bottom of the vessel or fin eject out of ship bottom. Therefore, it is very difficult to control the size and density of the air bubbles.

During the bad weather, the vessel has to face rough sea conditions. In the rough sea condition, wave height can reach in range of 2.5 meters to over 14 meters. The rough sea condition causes rolling, pitching surging, heaving, yawing and swaying in the vessel, due to which there are chances of damages on the vessel.

Further, one of most prominent issues which whole world is facing is a rising tide of plastic wastes. The rising tide of plastic wastes is choking our oceans, threatening fragile ecosystems and killing sea life. Many researchers have estimated that the amount of plastic in the ocean is expected to double in the next 15 years, and by 2050 there could be more plastic than fish in the sea (by weight).

Moreover, there is always a risk of the seabirds and sea creatures consuming plastic present in the water bodies. Sea life also chokes on plastic rubbish or gets tangled in it, often causing a painful slow death. Further, plastic pollution is contributing to the break-down of coral reefs.

As plastic in the water bodies breaks down, it creates micro-plastics. These micro-plastics get swallowed by fish and other sea creatures and end up in our food chain. The same also has adverse effects on the human health.

There are organizations such as United Nations which are working towards cleansing the water bodies. Most of such organizations have been focusing on a dedicated system to collect plastics from the water bodies. As the vessel transport is responsible for a large portion of world commerce, it will be advantageous to develop an apparatus which can be attached to the vessel and can collect micro-plastics from sea.

In view of the above limitations of the current technologies, there exists a need to develop an apparatus for an improved vessel design, which would in turn address a variety of issues including, but not limited to, reducing drag resistance upon a vessel, improving the speed of the vessel, improving fuel efficiency, providing better stability in rough sea conditions and collecting micro-plastics from sea.

Thus, the above-described deficiencies of conventional approaches including devices/products and methods thereof, are merely intended to provide an overview of some of the problems of conventional approaches and are not intended to be exhaustive. Other problems with conventional approaches, and methods and their corresponding benefits of the various non-limiting embodiments described herein may become further apparent upon review of the following description.

### SUMMARY OF THE INVENTION

The following presents a simplified summary of the invention to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

It is therefore the objective of the present invention to provide a bow structure which reduces drag resistance on the vessel, thus improving the speed and fuel efficiency of the vessel.

Another objective of the present inventive is to provide a vessel which can easily sails through a rough sea condition.

Yet another objective of the present invention is to provide a vessel as an apparatus to collect micro-plastics from sea.

Accordingly, in an aspect, the present invention provides a pair of extended arms coupled to the bow section of a vessel, wherein the pair of extended arms comprise a port side extended arm operationally coupled to a port side of the bow and a starboard side extended arm operationally coupled to a starboard side of the bow, the pair of extended arms configuring a trapezoid pool and bifurcating an incoming wave towards the vessel thereby reducing impact of wave resistance on the vessel.

In another aspect, the present invention provides each of the pair of extended arm having a proximal end and a distal end, the distal end of the port side extended arm is directed towards the distal end of the starboard side extended arm, forming the trapezoid pool.

In yet another aspect, the present invention provides the pair of extended arms configured to bifurcate the incoming wave towards the vessel into three portions: a port side wave directed towards the port side of the vessel, a starboard side wave directed towards the starboard side of the vessel and a center wave directed into the trapezoid pool through a gap between distal ends of the pair of extended arms.

In still another aspect, the present invention provides the pair of extended arms may extend or retract along length of the pair of extended arms.

In a further aspect, the present invention provides a vessel comprising a bow having a port side and a starboard side, a pair of extended arms comprising: a port side extended arm operationally coupled to the port side of the bow, and a starboard side extended arm operationally coupled to the starboard side of the bow, the pair of extended arms configuring a trapezoid pool and bifurcating an incoming wave towards the vessel thereby reducing impact of wave resistance on the vessel.

In another aspect, the present invention provides the bow is selected from a single indented bulbous bow having a curved bottom or a slide-shape bow or a non-bulbous bow having a vertical divided bow.

Accordingly, in another aspect, the present invention provides the bow has an inclination angle at bottom ranging between 30° to 90°.

Accordingly, in another aspect, the present invention provides the pair of extended arms may extend or retract along length of the pair of extended arms to act as a rudder of the vessel.

Accordingly, in another aspect, the present invention provides the distal end of the port side extended arm is directed towards the distal end of the starboard side extended arm, forming the trapezoid pool.

Accordingly, in another aspect, the present invention provides the pair of extended arms configured to bifurcate the incoming wave towards the vessel into three portions: a port side wave directed towards the port side of the vessel, a starboard side wave directed towards the starboard side of the vessel, and a center wave directed into the trapezoid pool through a gap between distal ends of the pair of extended arms.

Accordingly, in another aspect, the present invention provides the trapezoid pool facilities the generation of air bubbles by collisions of the center wave with the bow and the pair of extended arms.

Accordingly, in another aspect, the present invention provides an air bubble generating apparatus operationally coupled to the bow of the vessel and configured to inject air bubbles in the trapezoid pool.

Accordingly, in another aspect, the present invention provides the air bubble generating apparatus injects air bubbles at different injection angles above the bottom of the vessel to control the size and density of the air bubbles.

Accordingly, in another aspect, the present invention provides the air bubbles flow through a bottom of the vessel to create a layer of air bubbles between the bottom of the vessel and seawater.

Accordingly, in another aspect, the present invention provides the bow, the port side extended arm and the starboard side extended arm are supportably connected to each other through one or more supporting members.

Accordingly, in another aspect, the present invention provides a buttock stern having a 10°-60° of sliding structure in fine lines.

Accordingly, in another aspect, the present invention provides the vessel further comprising: a collection unit operationally coupled to the buttock stern and configured to collect the air bubbles contaminated with micro-plastics which are adhered to the air bubbles through seawater waves, a purifying unit operationally coupled to the collection unit and configured to separate the micro-plastics from the collected air bubbles, and at least one propeller operationally coupled to the buttock stern and at least one rudder disposed ahead of the at least one propeller to reduce the length of the buttock stern.

Other aspects, advantages, and salient features of the invention will become apparent to those skilled in the art from the following detailed description, which, details the invention in different embodiments.

### BRIEF DESCRIPTION OF THE DRAWINGS

While the specification concludes with claims that particularly point out and distinctly claim the invention, it is believed that the advantages and features of the present invention will become better understood with reference to the following more detailed description of expressly disclosed exemplary embodiments taken in conjunction with the accompanying drawings. The drawings and detailed description which follow are intended to be merely illustrative of the expressly disclosed exemplary embodiments and are not intended to limit the scope of the present invention as set forth in the appended claims. In the drawings:

FIG. 1 illustrates a schematic side view of a vessel adopted in an embodiment of the invention;

FIG. 2 illustrates a schematic bottom view of a vessel bow section adopted in an embodiment of the invention;

FIG. 3a illustrates a schematic side view of the vessel bow section having a bulbous bow cut in a center axis along length of the vessel adopted in an embodiment of the invention;

FIG. 3b illustrates a schematic side view of the vessel bow section having a vertical bow cut in a center axis along length of the vessel adopted in an embodiment of the invention;

FIG. 3c illustrates a schematic perspective view of the vessel bow section having an support structure adopted in an embodiment of the invention;

FIG. 3d illustrates a schematic front view of the vessel bow section having an support structure adopted in an embodiment of the invention;

FIG. 4 illustrates a schematic view of bow section in which an air bubbles generating apparatus injecting air bubbles above a bottom of the vessel adopted in an embodiment of the invention; and

FIG. 5 illustrates a schematic enhanced view of a stern of the vessel adopted in an embodiment of the invention.

### DETAILED DESCRIPTION OF THE INVENTION

### Call Out List

10 Vessel
100 Bow
101 Port side extended arm
102 Starboard side extended arm
103 Trapezoid pool
α Inclination angle
104 Air bubble generating apparatus
104a Fin
105 Support Members
200 Stern
β Sliding angle
200a Holes on the sliding structure of the stern
201 Propeller
202 Rudder
203 Collection unit
203a Vertical tube
203b Vacuum pump
203c Water tank
204 Purifying unit
300 Bottom of the vessel
500 Air bubbles
D Distance between proximal ends of the pair of extended arm
g Gap between distal ends of the pair of extended arm
W Sea water level

The exemplary embodiments described herein detail for illustrative purposes are subject to many variations in the structure and configuration. It should be emphasized, however, that the present invention is not limited to a particular composition as shown and described herein. It is understood that various omissions and substitutions of equivalents are contemplated as circumstances may suggest or render expedient, but these are intended to cover the application or implementation without departing from the scope of the claims of the present invention. Also, it is to be understood that the phraseology and terminology used herein is for the purpose of description and should not be regarded as limiting.

The use of terms “including,” “comprising,” or “having” and variations thereof herein are meant to encompass the items listed thereafter and equivalents thereof as well as additional items.

Further, the terms, “an” and “a” herein do not denote a limitation of quantity, but rather denote the presence of at least one of the referenced item.

Furthermore, the term “may” herein is used in a permissive sense (i.e. meaning having the potential to), rather than the mandatory sense, (i.e. meaning must).

Furthermore, the term “vessel” herein is used to represent a watercraft used for travel on water. It may be but not limited to a ship or a boat.

The present invention provides design of a vessel which reduces drag resistance on the vessel, thus improves vessel's speed and fuel efficiency. Further, the vessel can sail through a rough sea condition and can collect micro-plastics from sea.

An exemplary embodiment of the present invention will be described with reference to the attached drawings.

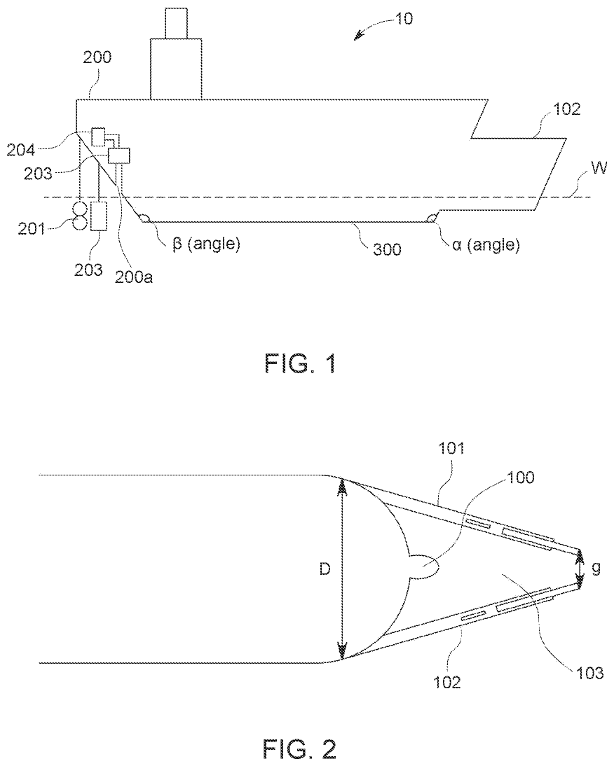

FIG. 1 is a schematic side view of a vessel 10 adopted in an embodiment of the invention. The vessel 10 may be but not limited to a cargo ship, a passenger ship, a defense ship, a research ship or a fishing ship. The vessel 10 may comprises a bow section and a stern 200. The reference sign 300 represents a bottom of the vessel 10. The bottom 300 of the vessel 10 may be a flat surface. Further, the reference sign W represents the water level of the sea.

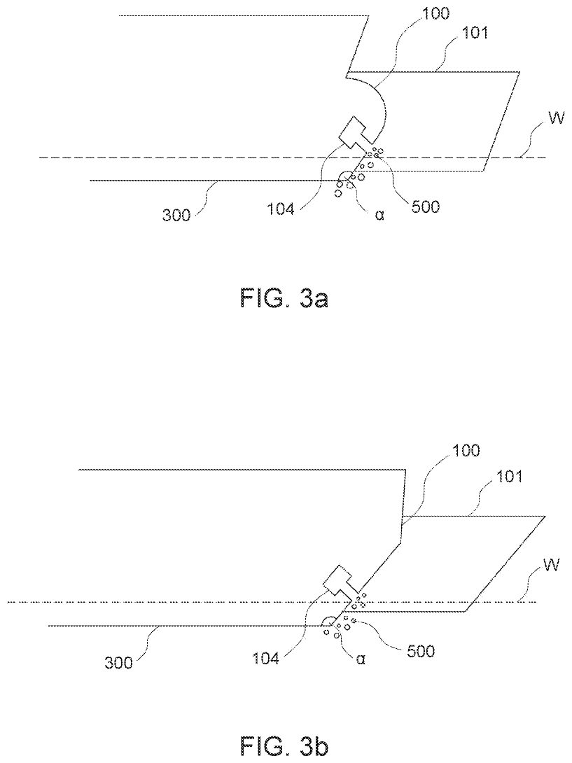

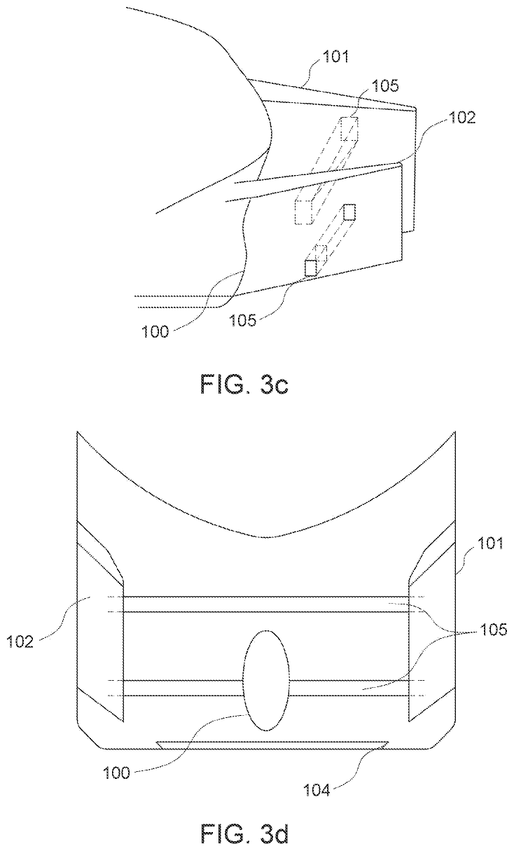

FIG. 2 is a schematic bottom view of the bow section of the vessel 10 adopted in an embodiment of the invention. The bow section may comprises a bow 100 and a pair of extended arms 101, 102. The bow 100 may be disposed on middle of the bow section of the vessel 10. The bow 100 may be selected from but not limited to a single indented bulbous bow as illustrated in FIG. 3a and a slide-shape vertical bow as illustrated in FIG. 3b. The single indented bulbous bow may be curved on bottom side of the single indented bulbous. The curved bottom of single indented bulbous bow or a slide-shape vertical bow may have an inclination angle a ranging between 30° to 90°.

The pair of extended arms 101, 102 may comprise a port side extended arm 101 operationally coupled to the port side of the bow 100 and a starboard side extended arm 102 operationally coupled to the starboard side of the bow 100 in forward direction of the vessel 10. Proximal ends of the pair of extended arms 101, 102 may be coupled to the vessel 10. The proximal ends of the pair of extended arms 101, 102 may be separated in port-starboard direction of the vessel 10 by a distance D. Distal end of the port side extended arm 101 may be directed towards the distal end of the starboard side extended arm 102. The distal ends of the pair of extended arms 101, 102 may be separated with each other in the port-starboard direction such that a gap g may be created between them. The gap g between the distal ends of the pair of extended arms 101, 102 is may be less than the distance D between the proximal ends of the pair of extended arms 101, 102. Further, the distal ends of the extended arms 101, 102 may have sharper angle than the bow 100.

The pair of extended arms 101, 102 may be configured to bifurcate an incoming wave towards the vessel 10 into three portions: a port side wave which may be directed towards port side of the vessel 10, a starboard side wave which may be directed towards starboard side of the vessel 10 and a center wave which may enter through the gap g in a confined space surrounded by the pair of extended arms 101, 102 and the bow 100. This confined space may be called as a trapezoid pool 103. As the incoming wave may be bifurcated into three directions, intensity and energy of the incoming wave may also be divided, thus the center wave which may reaches to the vessel 10 may have less intensity and energy. Due to this, impacts of the waves on the vessel 10 may get reduced significantly. It may be expected that height of the center wave may be 0.5m to 2m less than the incoming wave, depending upon the sea condition. As a result, the vessel 10 may easily sails through a rough sea condition.

In the trapezoid pool 103, the center wave may enter through the gap g and may collides with the bow 100 and inner walls of the pair of extended arms 101, 102. Due to this collision, air bubbles 500 may generate naturally in the trapezoid pool 103.

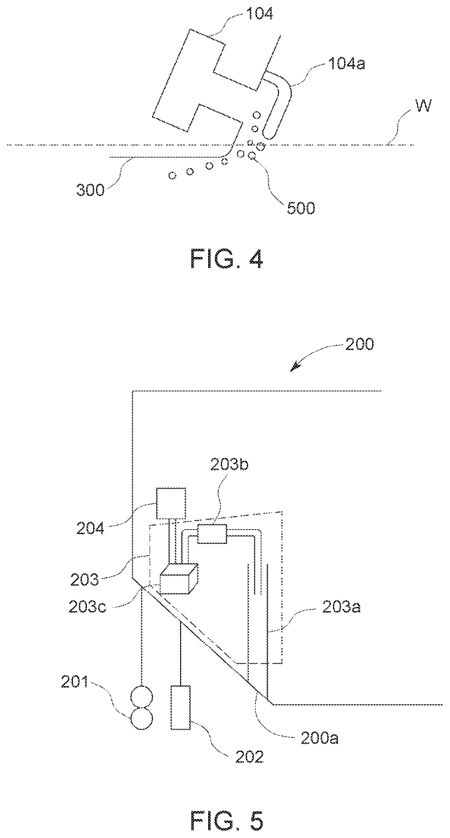

Additionally, an air bubble generating apparatus 104 may be provided on the vessel 10 which may be operationally coupled to the bow 100 of the vessel 10 as illustrated in FIG. 4. The air bubble generating apparatus 104 may comprise an air blower, an air compressor or any other dedicated system may use to create air bubbles 500. The air bubble generating apparatus 104 may be configured to provide additional air bubbles 500 in the trapezoid pool 103. The air bubble generating apparatus 104 may be injecting the air bubble 500 in the trapezoid pool 103 at different injection angles on an injection point which may be higher than a bottom 300 of the vessel 10 to create air bubbles of different size. The air bubble generating apparatus 104 may be provided as a fin 104a which may be coupled with the bow 100 at a small distance above the bottom 300 of the vessel 10. The fin 104a may provide the low-pressure region above the fin 104a as the vessel 10 moves forward. The low pressure may drives the atmospheric air to a critical water depth without significant air compression, depending on the flow conditions around the fin 104a, the shape of the fin, the angle of attack, and other factors. As, the fin 104a may be located at a small distance above the bottom 300 of the vessel 10 so that air and water join smoothly to flow out downstream. Small bubbles may generated by the instability of the air-water interface, which may be subject to a high shear rate along the surface of the fin 104a. The number density of bubbles may increases with the subsequent wave-breaking phenomenon which may occurs just behind the fin 104a. The air bubble generating apparatus 104 may generates the small bubbles without the use of bubble fragmentation devices such as porous plates.

As the bow 100 may have a curved or inclined bottom, the center wave may flow from the trapezoid pool 103 to the bottom 300 of the vessel 10. Further, the air bubbles 500 may flow from the trapezoid pool 103 to the bottom 300 of the vessel 10 with the center wave. There may be a constant flow of the air bubbles 500 to the bottom 300 of the vessel 10. At the bottom 300 of the vessel 10, a layer of the air bubbles 500 may form between the bottom 300 of the vessel 10 and the sea water, as illustrated in FIG. 4. Due to the layer of the air bubbles 500, the drag resistance between the vessel 10 and the sea water will reduce. Therefore, fuel efficiency of the vessel increases.

Additionally, support members 105 may be connected to the pair of extended arms 101, 102 to provide more strength to the pair of extended arms 101, 102 as illustrated in FIG. 3c and FIG. 3d. The support members 105 may comprises at least one or more horizontal members. One end of the support members 105 may be coupled to top portion of the port side extended arm 101 and other end of the support member 105 may be coupled to top portion of the starboard side extended arm 102. Similarly, one end of another support members 105 may be coupled to bottom portion of the port side extended arm 101 and other end of the another support member 105 may be coupled to bottom portion of the starboard side extended arm 102. The support members 105 may be configured to supportably connect the port side extended arm 101 and the starboard side extended arm 102. Shape of the horizontal members may be selected from but no limited to cube, cuboid, triangular prism and cylinder. The support structure 105 may be configured to provide strength to the pair of extended arms 101,102 to withstand the forces of waves, hurricanes or typhoons.

The pair of extended arms 101, 102 may be manufactures using a variety of materials selected from steel, fibre-reinforced plastic (FRP), titanium or the like. The pair of extended arms 101,102 may be welded or 3-D printed to the vessel 10. Further, for a low temperature resistance steel which may withstand minus 50° C. temperature may be selected as material for the pair of extended arms 101, 102 such that the vessel 10 may sail in an ice sailing conditions.

In an embodiment of the present invention, length of the extended arms 101, 102 may be adjustable in the length direction of the extended arms 101, 102 (as illustrated in FIG. 2). The extended arms 101, 102 may be extended by sliding it along the length of the extended arms 101, 102 through a telescopic mechanism or by adding modules to extend the length. The telescopic mechanism may include but not limited to a wire pull, a pneumatic cylinder and a gears system to extend/retract the extended arms. If the length of the port side extended arm 101 is equal to the length of the starboard side extended arm 102, then due to symmetrical design of the vessel 10 along a center line, water flows evenly around the vessel. Therefore, no turning force may generate and the vessel may travel in a straight line. If the length of the port side extended arm 101 is extended and becomes more than the length of the starboard side extended arm 102, such that the water flow may be directed towards the port side direction of the vessel. Due to the extra water on the port side, high pressure may get generated on said side. This induces a force towards the low pressure side and the vessel may turned towards starboard side. Similarly, if the length of the starboard side extended arm 102 is extended and becomes more than the length of the port side extended arm 101, then the water flow may get directed towards the starboard side direction of the vessel 10. Due to the extra water on the port side, high pressure may get generated on said side. This induces a force towards the low pressure side and the vessel 10 may turned towards ports side. Thus, the extended arms 101, 102 may act as a rudder of the vessel.

FIG. 5 is a schematic view of the stern 200 adopted in an embodiment of the invention. The stern 200 may comprises one or a plurality of propeller 201 and one or a plurality of rudder 202. The plurality of propeller 201 may be disposed in bottom 300 of the vessel 10 in the stern 200. The plurality of rudder 202 may be disposed ahead of the plurality of propeller 201 in the stern 200. As a result, the vessel 10 may get shorten, for example, about 5 m to 20 m in comparison with a vessel having rudder in rear side of propeller. This saving in the vessel 10 length may be utilized to make the pair of extended arms 101,102 longer and sharper without increasing overall length of the vessel 10.

Further, the stern 200 may have a rectangular or buttock shape. The buttock stern 200 may have a 10-60° angle of sliding structure β as illustrated in FIG. 5. The sliding structure may be configured to collect almost all of the air bubble 500. A series of holes 200a may be provided on the sliding structure in the portside and starboard direction of the vessel 10. The sliding structure may provide the low-pressure region above the sliding structure as the vessel 10 moves forward. The low pressure may drive the air bubble 500 into the holes 200a, thus collecting the air bubbles 500.

In an exemplary embodiment, if the center wave carries micro-plastics, then the micro-plastics may enter into the trapezoid pool 103 through gap g between the pair of extended arms 101, 102. The micro-plastics are hydrophobic in nature, due to which the micro-plastics may get adhere to the air bubbles 500 in the trapezoid pool 103. The air bubbles 500 may flow with the center wave to the bottom 300 of the vessel 10, the micro-plastics get adhered to the air bubbles 500 and flow to the bottom 300 of the vessel 10. Further, the micro-plastics which flow below the water level will also adhere to the air bubbles 500.

The buttock stern 200 may further comprises a collection unit 203 and the purifying unit 204. The collection unit 203 may be configured to collect micro-plastics adhered air bubbles 500 at the stern section 200. The collection unit 203 may be coupled to the holes 200a provided on the sliding structure. The collection unit 203 may comprise a vertical tube, a vacuum machine and a water tank. The vertical tube may be coupled to the holes. Due to low pressure created above the sliding structure, the micro-plastics get adhered to the air bubbles 500 and water may rise upward in the vertical tube. One end vacuum machine may be coupled to the vertical tube and other end may be coupled to the water tank. The vacuum tube may be configured to transfer the micro-plastics adhered to the air bubbles 500 along with water to the water tank. The water tank may be configured to accumulate the micro-plastics adhered to the air bubbles along with water. When an adequate amount of micro-plastics get accumulated in the water tank, the accumulation of the micro-plastics, bubbles and sea water are transferred to the purifying unit 204. The purifying unit 204 may be coupled to the collection unit. The purifying unit 204 is configured to separate micro-plastic from the air bubbles, sea water or the like. The micro-plastics may be stored in the vessel 10 and air bubbles and sea water can be ejected from the vessel 10. The vessel 10 may be configured to reduce the micro-plastics using microwaves, ultrasonic waves or the same may get disposed when the vessel reaches a shore.

The foregoing descriptions of exemplary embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

I claim:

1. A pair of extended arms (101, 102) coupled to a bow section of a vessel (10), the pair of extended arms (101, 102) comprising:
a port side extended arm (101) operationally coupled to a port side of the bow (100); and
a starboard side extended arm (102) operationally coupled to a starboard side of the bow (100),
the pair of extended arms (101, 102) configuring a trapezoid pool (103) and bifurcating an incoming wave towards the vessel (10) thereby reducing impact of wave resistance on the vessel (10).

2. The pair of extended arms (101, 102) as claimed in claim 1, wherein each of the pair of extended arm (101, 102) having a proximal end and a distal end, the distal end of the port side extended arms (101) is directed towards the distal end of the starboard side extended arm (102), forming the trapezoid pool (103).

3. The pair of extended arms (101, 102) as claimed in claim 2, wherein the pair of extended arms (101, 102) configured to bifurcate the incoming wave towards the vessel (10) into three portions:
a port side wave directed towards the port side of the vessel (10);
a starboard side wave directed towards the starboard side of the vessel (10); and
a center wave directed into the trapezoid pool (103) through a gap (g) between distal ends of the pair of extended arms (101, 102).

4. The pair of extended arms (101, 102) as claimed in claim 1, wherein the pair of extended arms (101, 102) may extend or retract along length of the pair of extended arms (101, 102).

5. A vessel (10) comprising:
a bow (100) having a port side and a starboard side;
a pair of extended arms (101, 102) comprising:
a port side extended arm (101) operationally coupled to the port side of the bow (100), and
a starboard side extended arm (102) operationally coupled to the starboard side of the bow (100),
the pair of extended arms (101, 102) configuring a trapezoid pool (103) and bifurcating an incoming wave towards the vessel (10) thereby reducing impact of wave resistance on the vessel (10).

6. The vessel (10) as claimed in claim 5, wherein the bow (100) is selected from a single indented bulbous bow or vertical bow having a curved bottom or a slide-shape bow.

7. The vessel (10) as claimed in claim 6, wherein the bow (100) has an inclination angle (a) at bottom ranging between 30° to 90°.

8. The vessel (10) as claimed in claim 5, wherein the pair of extended arms (101, 102) may extend or retract along length of the pair of extended arms (101, 102) to act as a rudder of the vessel (10).

9. The vessel (10) as claimed in claim 5, wherein each of the pair of extended arms (101, 102) having a proximal end and a distal end, the distal end of the port side extended arm (101) is directed towards the distal end of the starboard side extended arm (102), forming the trapezoid pool (103).

10. The vessel (10) as claimed in claim 9, wherein the pair of extended arms (101, 102) configured to bifurcate the incoming wave towards the vessel (10) into three portions:
a port side wave directed towards the port side of the vessel (10);
a starboard side wave directed towards the starboard side of the vessel (10); and
a center wave directed into the trapezoid pool (103) through a gap (g) between distal ends of the pair of extended arms (101, 102).

11. The vessel (10) as claimed in claim 10, wherein the trapezoid pool (103) facilities the generation of air bubbles (500) by collisions of the center wave with the bow (100) and the pair of extended arms (101, 102).

12. The vessel (10) as claimed in claim 11, further comprising an air bubble generating apparatus (104) operationally coupled to the bow (100) of the vessel (10) and configured to inject air bubbles (500) in the trapezoid pool (103), wherein the air bubble generating apparatus (104) injects air bubbles (500) at different injection angles above a bottom (300) of the vessel (10) to control the size and density of the air bubbles (500).

13. The vessel (10) as claimed in claim 12, wherein the air bubbles (500) flow through the bottom (300) of the vessel (10) to create a layer of air bubbles (500) between the bottom (300) of the vessel (10) and seawater.

14. The vessel (10) as claimed in claim 5, wherein the bow (100), the port side extended arm (101) and the starboard side extended arm (102) are supportably connected to each other through one or more supporting members (105).

15. The vessel (10) as claimed in claim 5, further comprising a buttock stern (200) having a 10°-60° of sliding structure (β).

16. The vessel (10) as claimed in claim 15, further comprising:
a collection unit (203) operationally coupled to the buttock stern (200) and configured to collect the air bubbles (500) contaminated with micro-plastics which are adhered to the air bubbles (500) through seawater waves;
a purifying unit (204) operationally coupled to the collection unit (203) and configured to separate the micro-plastics from the collected air bubbles (500), and;
at least one propeller (201) operationally coupled to the buttock stern (200); and
at least one rudder (202) disposed ahead of the at least one propeller (201) to reduce the length of the vessel (10).
